(19) United States
(12) Patent Application Publication
(10) Pub. No.: US 2024/0221093 A1
(43) Pub. Date: Jul. 4, 2024

(54) METHOD AND DEVICE CONFIGURED FOR ASSISTING USER IN CARING FOR PLANT

(71) Applicant: Hangzhou Ruisheng Software Co., Ltd., Zhejiang (CN)

(72) Inventors: Mingquan Chen, Zhejiang (CN); Huan Luo, Zhejiang (CN); Qingsong Xu, Zhejiang (CN); Liang Li, Zhejiang (CN); Tao He, Zhejiang (CN)

(73) Assignee: Hangzhou Ruisheng Software Co., Ltd., Zhejiang (CN)

(21) Appl. No.: 18/518,427

(22) Filed: Nov. 22, 2023

(30) Foreign Application Priority Data
Dec. 30, 2022 (CN) 202211723259.X

(51) Int. Cl. G06Q 50/02; A01G 7/06

(52) U.S. Cl. CPC G06Q 50/02; A01G 7/06

(57) ABSTRACT

The disclosure provides a method configured for assisting a user in caring for a plant, including: acquiring a plant species in response to a request for analyzing a caring situation submitted by the user and outputting caring-related questions to the user, so as to determine a user caring plan through answers to the questions from the user; determining a reference caring plan according to the plant species; determining a mistake in the user caring plan based on a difference between the user caring plan and the reference caring plan; and outputting prompt information related to plant caring to the user based on the mistake. A device configured for assisting a user in caring for a plant is also provided.

### CROSS-REFERENCE TO RELATED APPLICATION

This application claims the priority benefit of China application serial no. 202211723259.X, filed on Dec. 30, 2022. The entirety of the above-mentioned patent application is hereby incorporated by reference herein and made a part of this specification.

### BACKGROUND

### Technical Field

The disclosure relates to the technical field of information processing, and in particular, relates to a method and device configured for assisting a user in caring for a plant.

### Description of Related Art

Many people like to have plants in their workplace or living space because plants can not only be used to beautify the home and make people feel better, but they can also be used to purify indoor air, so plants are beneficial to human health. However, in order for plants to grow healthily, plants need to be cared for regularly.

### SUMMARY

One of the objectives of one or more embodiments of the disclosure is to provide a method and device configured for assisting a user in caring for a plant and a computer-readable storage medium.

The first aspect of the embodiments of the disclosure provides a method configured for assisting a user in caring for a plant, and the method includes the following steps. A plant species is acquired in response to a request for analyzing a caring situation submitted by the user, and caring-related questions are outputted to the user, so as to determine a user caring plan through answers to the questions from the user. A reference caring plan is determined according to the plant species. A mistake in the user caring plan is determined based on a difference between the user caring plan and the reference caring plan. Prompt information related to plant caring is outputted to the user based on the mistake.

In some embodiments, the questions involve one or more aspects among light conditions, planting locations, water conditions, fertilizer conditions, soil conditions, flower pot conditions, climate conditions, and planting duration.

In some embodiments, the method further includes the following step. The questions are generated according to the plant species before the questions are outputted.

In some embodiments, the method further includes the following steps. Caring abilities and/or planting experiences of the user are acquired before the questions are outputted. The questions are generated based on the caring abilities and/or the planting experiences.

In some embodiments, the questions further involve caring abilities and/or planting experiences.

In some embodiments, the method further includes the following steps. At least one of disease and insect pest information and health information of the plant is acquired before the mistake is determined. The disease and insect pest information includes one or more of fungal diseases, bacterial diseases, viral diseases, nematode diseases, aphids, fruit flies, spider mites, scale insects, and whiteflies. The health information includes one or more of lack of water, lack of light, and lack of ventilation. The mistake is determined based on at least one of the disease and insect pest information and the health information and the difference.

In some embodiments, the prompt information includes a description of the mistake and/or a suggestion related to the reference caring plan.

In some embodiments, the prompt information includes at least one of the disease and insect pest information and the health information and a description of a plant status corresponding to at least one of the disease and insect pest information and the health information.

In some embodiments, the method further includes the following steps. A plant image is acquired, and at least one of the disease and insect pest information and the health information of the plant is determined based on the plant image. A related portion is marked on the plant image according to at least one of the disease and insect pest information and the health information. The outputting the prompt information includes outputting the marked plant image.

In some embodiments, the questions involve the light conditions, and the light conditions include one or more of full sun, partial sun, full shade, and indirect sunlight. The outputting the questions includes outputting an introduction of each of the light conditions.

In some embodiments, the method further includes the following steps. Planting experiences and/or caring abilities of the user are acquired before the questions are outputted. Whether to output the introduction of each of the light conditions to the user is determined based on the planting experiences and/or the caring abilities.

In some embodiments, the method further includes the following step. The introduction of each of the light conditions is outputted in response to a specific operation by the user when the questions are outputted.

In some embodiments, the acquiring the plant species includes: acquiring directly from the user through human-computer interaction; and/or acquiring according to a plant image inputted by the user through computer vision technology.

In some embodiments, in response to receiving the request for analyzing the caring situation submitted by the user for the first time, the questions involve one or more aspects among caring abilities, planting experiences, and climate conditions, and involves one or more aspects among light conditions, planting locations, water conditions, fertilizer conditions, soil conditions, flower pot conditions, and planting duration. In response to receiving the request for analyzing the caring situation submitted by the user not for the first time, the questions involve one or more aspects among the light conditions, the planting locations, the water conditions, the fertilizer conditions, the soil conditions, the flower pot conditions, and the planting duration.

In some embodiments, the questions involve up to five aspects among the light conditions, the planting locations, the water conditions, the fertilizer conditions, the flower pot conditions, and the planting duration.

In some embodiments, in response to receiving the request for analyzing the caring situation for the first time among the two received consecutive requests for analyzing the caring situation submitted by the user, the questions are a first subset of questions. In response to receiving the request for analyzing the caring situation for the second time among the two received consecutive requests for analyzing the caring situation submitted by the user, the questions are a second subset of questions. Herein, both the first subset of questions and the second subset of questions include all aspects among the light conditions, the planting locations, the water conditions, the fertilizer conditions, the soil conditions, the flower pot conditions, and the planting location. The first subset of questions and the second subset of questions do not completely overlap.

The second aspect of the embodiments of the disclosure further provides a device configured for assisting a user in caring for a plant including an acquisition module, a first determination module, a second determination module, and a prompt module. The acquisition module is configured to acquire a plant species in response to a request for analyzing a caring situation submitted by the user and output caring-related questions to the user, so as to determine a user caring plan through answers to the questions from the user. The first determination module is configured to determine a reference caring plan according to the plant species. The second determination module is configured to determine a mistake in the user caring plan based on a difference between the user caring plan and the reference caring plan. The prompt module is configured to output prompt information related to plant caring to the user based on the mistake.

The third aspect of the embodiments of the disclosure further provides a device configured for assisting a user in caring for a plant including a memory and a processor coupled to the memory. The processor is configured to execute the method according to any one of the foregoing embodiments based on a command stored in the memory.

The fourth aspect of the embodiments of the disclosure further provides a computer-readable storage medium including a computer program command. The computer program command implements the method according to any one of the foregoing embodiments when being executed by a processor.

The fifth aspect of the embodiments of the disclosure further provides a computer program product including a computer program. The computer program implements the method according to any one of the foregoing embodiments when being executed by a processor.

The technical solutions of the disclosure are further described in detail in combination with the accompanying drawings and embodiments.

### BRIEF DESCRIPTION OF THE DRAWINGS

To make the technical solutions provided in the embodiments of the disclosure or the related art more clearly illustrated, several accompanying drawings required by the embodiments or the related art for description are briefly introduced as follows. Obviously, the drawings in the following description are merely some embodiments of the disclosure, and for a person having ordinary skill in the art, other drawings can be obtained based on these drawings without an inventive effort.

FIG. 1 is a schematic flow chart of a method configured for assisting a user in caring for a plant according to some embodiments of the disclosure.

FIG. 2 is a schematic image of a page for plant image capturing in the method configured for assisting the user in caring for the plant according to some embodiments of the disclosure.

FIG. 3A to FIG. 3D are schematic images of pages for displaying caring-related questions in the method configured for assisting the user in caring for the plant according to some embodiments of the disclosure.

FIG. 4 is a schematic image of a waiting page in the method configured for assisting the user in caring for the plant according to some embodiments of the disclosure.

FIG. 5A and FIG. 5B are schematic images of pages for displaying prompt information related to plant caring in the method configured for assisting the user in caring for the plant according to some embodiments of the disclosure.

FIG. 6A to FIG. 6D are schematic images of pages for displaying the caring-related questions in the method configured for assisting the user in caring for the plant according to some embodiments of the disclosure.

FIG. 7 is a schematic structural view of a device configured for assisting a user in caring for a plant according to some embodiments of the disclosure.

FIG. 8 is a schematic structural view of a device configured for assisting a user in caring for a plant according to some other embodiments of the disclosure.

### DESCRIPTION OF THE EMBODIMENTS

Description will now be made in detail to clearly and completely present preferred embodiments of the disclosure, examples of which are illustrated in the accompanying drawings. Nevertheless, the disclosed embodiments are merely part of the embodiments of the disclosure, not all the embodiments. Based on the embodiments of the disclosure, all other embodiments obtained by a person having ordinary skill in the art without making any inventive effort fall within the scope that the disclosure seeks to protect.

The relative arrangement of the components and steps, numerical expressions, and numerical values set forth in these embodiments do not limit the scope of the disclosure unless specifically stated otherwise.

Meanwhile, it should be understood that, for the convenience of description, the dimensions of various parts shown in the accompanying drawings are not drawn in an actual proportional relationship.

Techniques, methods, and apparatuses known to a person having ordinary skill in the art may not be discussed in detail, but where appropriate, such techniques, methods, and apparatuses should be considered part of the specification.

In all examples shown and discussed herein, any specific value should be construed as illustrative only and not as limiting. Accordingly, other examples of exemplary embodiments may have different values.

It should be noted that similar numerals and letters refer to similar items in the following figures. Therefore, once an element is defined in one figure, no further discussion of the element is required in subsequent figures.

The inventors have noticed that due to lack of caring experiences, lack of understanding of plant characteristics, and other reasons, people are likely to make various care mistakes and problems in the process of plant caring, which will eventually lead to poor plant health and even infection by diseases and insect pests. In order to assist users in better plant caring, the inventors provide the following method.

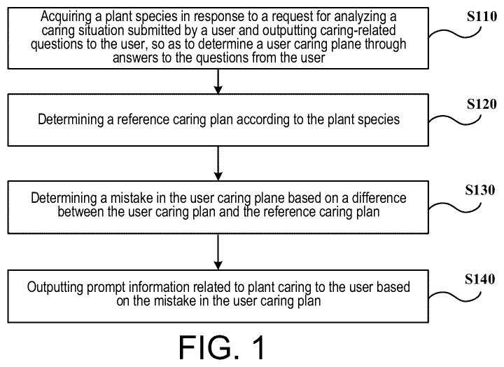

FIG. 1 is a schematic flow chart of a method configured for assisting a user in caring for a plant according to some embodiments of the disclosure. The method may be executed by an application program installed on an electronic apparatus such as a computer, a mobile phone, etc., to provide the user with functions that assist the user in plant caring. The method may include step S110, step S120, step S130, and step S140 as described in the following paragraphs.

In step S110, in response to a request for analyzing a caring situation submitted by the user, a plant species is acquired, and caring-related questions are outputted to the user, so as to determine a user caring plan through answers to the questions from the user.

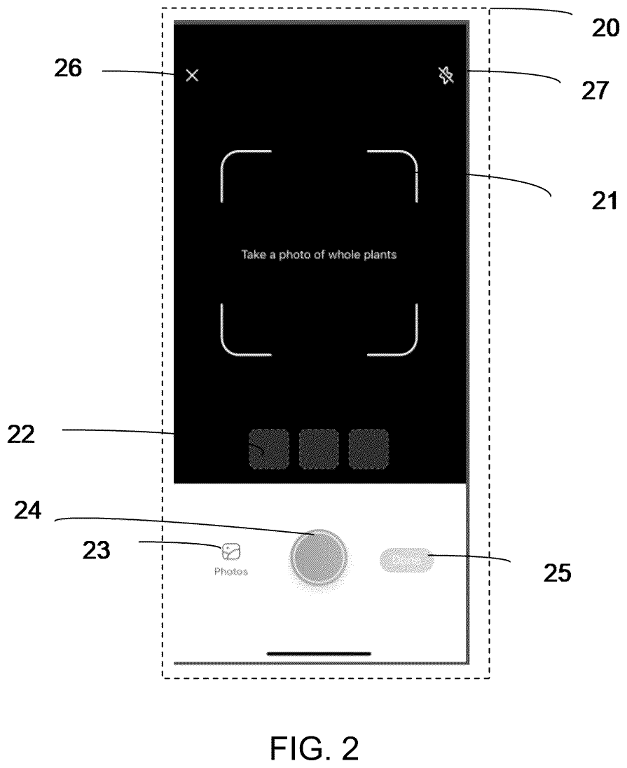

The user can submit the request for analyzing the caring situation in a variety of ways. In some embodiments, the application program can provide an interface area for user operation, such as a button, so that the user can submit the request for analyzing the caring situation by operating the interface area. In some embodiments, the application program can receive the request for analyzing the caring situation by receiving a plant image from the user. The application program may, for example, present to the user a page for plant image capturing as shown in FIG. 2, and when the user uploads one or more images of a plant through this page, the user can be considered to submit the request for analyzing the caring situation.

In some embodiments, the plant species may be acquired directly from the user through human-computer interaction, and/or the plant species may be acquired (e.g., recognized) based on the plant image inputted by the user through computer vision technology. Acquiring the plant species directly from the user is, for example, outputting a question related to the plant species to the user, so as to determine the plant species through the user's answer. Acquiring the plant species based on the plant image inputted by the user through the computer vision technology can be, for example, displaying the page for plant image capturing as shown in FIG. 2 to the user, and the plant species may thus be acquired through the plant image captured by the user.

As shown in FIG. 2, a page for plant image capturing 20 includes an area 21 for captured content displaying, an area 22 for captured image thumbnail displaying, a button 23 for photo album opening, a button 24 for taking a photo, a photo-taking completion button 25, a button 26 for page closing, and a button 27 for flash setting. As some implementations, in addition to displaying the captured content, the area 21 for captured content displaying may also display photo-taking tips, such as “Take a photo of whole plant”, so that the user may know the function of the page 20 and how to take a photo. The user can click the button 24 for taking a photo to take a photo, and after a photo is taken, the image captured by the user will be displayed in the area 22. As some implementations, the user can operate the area 22 to view or delete part of the captured images. In some embodiments, in addition to directly capturing a plant image, the user can also select a photo from a photo album for recognition through the computer vision technology. For instance, the user can operate the button 23 for photo album opening to open the photo album and select a plant image therefrom, and the plant image selected by the user can also be displayed in the area 22. After the user clicks the photo-taking completion button 25, the image corresponding to the thumbnail in the area 22 may be recognized by the computer vision technology, whereby the plant species can be determined.

In some embodiments, the caring-related questions involve one or more aspects among light conditions, planting locations, water conditions, fertilizer conditions, soil conditions, flower pot conditions, climate conditions, and planting duration. Further, the caring-related questions may also involve caring abilities and/or planting experiences. As some implementations, the caring-related questions may be determined based on one or more factors including the plant species and the number of requests for analyzing the caring situation submitted by the user, which is going to be introduced in the following paragraphs with reference to some embodiments.

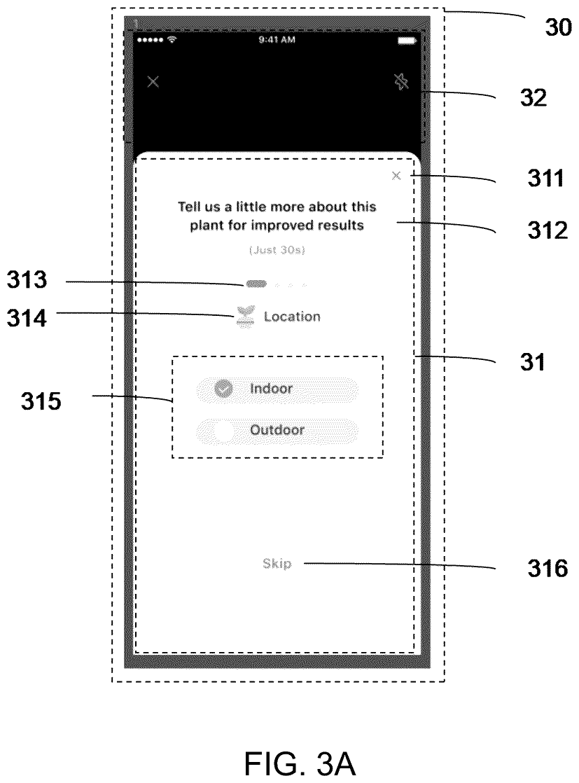

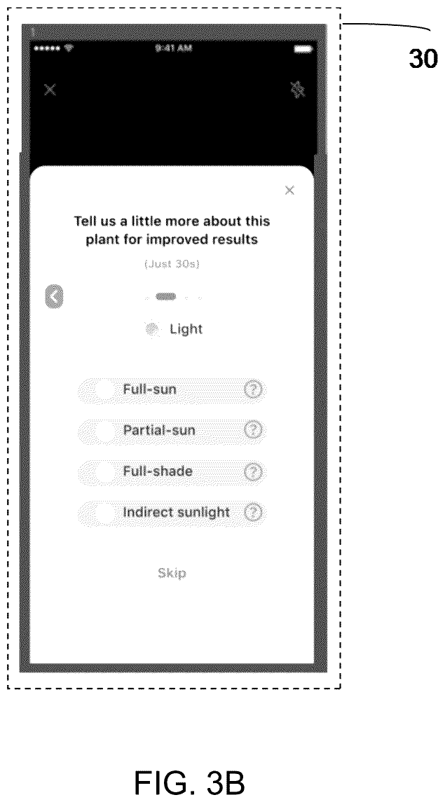

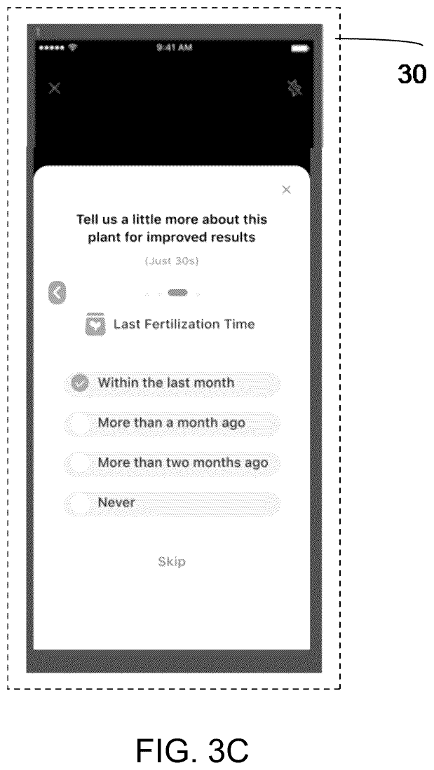

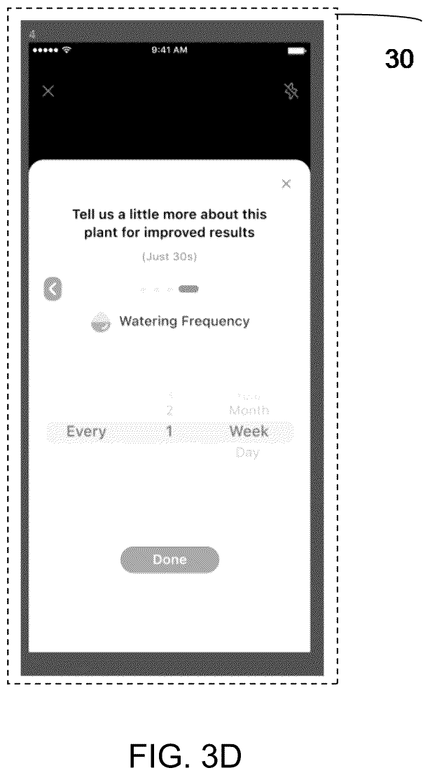

FIG. 3A to FIG. 3D are schematic images of pages for displaying caring-related questions in the method configured for assisting the user in caring for the plant according to some embodiments of the disclosure. Herein, FIG. 3A may be used to display a question related to the planting locations, FIG. 3B may be used to display a question related to the light conditions, FIG. 3C may be used to display a question related to the fertilizer conditions, and FIG. 3D may be used to display a question related to the water conditions. The following mainly introduces how to display the caring-related question with reference to FIG. 3A, and the introduction to FIG. 3A may also serve as reference for introduction to FIG. 3B to FIG. 3D.

As shown in FIG. 3A, a page 30 for displaying a caring-related question may include a sub-area 31 and a sub-area 32. The sub-area 32 may be used to display a plant image, such as the plant image acquired in step S110. The sub-area 31 may include a sub-area closing button 311, a page introduction 312, a paging indicator 313, a caring-related question 314, a sub-area 315 for the user to answer the caring-related question, and a skip or done button 316.

In response to the user operating the sub-area closing button 311, the sub-area 31 may be closed. The page introduction 312 is, for example, “Tell us a little more about this plant for improved results”. As some implementation, the page introduction 312 may also include the time required for the user to answer the caring-related question, such as “just 30s”. This allows the user to have a general understanding of the time he/she needs to spend when answering the caring-related question, and user experience may thus be improved in this way. The paging indicator 313 is used to display an index of a current page to the user. For instance, there are a total of four pages in FIG. 3A to FIG. 3D, and correspondingly, the paging indicator 313 may include three dots and one rounded rectangle. The colors of the rounded rectangle and the dots may be inconsistent to better highlight the position of the rounded rectangle in the paging indicator 313. In the case where FIG. 3A is shown to the user, the rounded rectangle may be located in a first position in the paging indicator 313, and in the case where FIG. 3B is shown to the user, the rounded rectangle may be located in a second position in the paging indicator 313. By setting the paging indicator 313, the user can intuitively know which page the current page is. In this way, the user can easily understand the progress of his/her answer when answering the caring-related question. The caring-related question 314 is, for example, “Location”. In some embodiments, the caring-related question 314 may also include an icon related to the question, so that the user can intuitively understand the question he/she needs to answer. The sub-area 315 for the user to answer the caring-related question may include options corresponding to the caring-related question 314, for example, the options corresponding to the question “Location” may include “Indoor” and “Outdoor”.

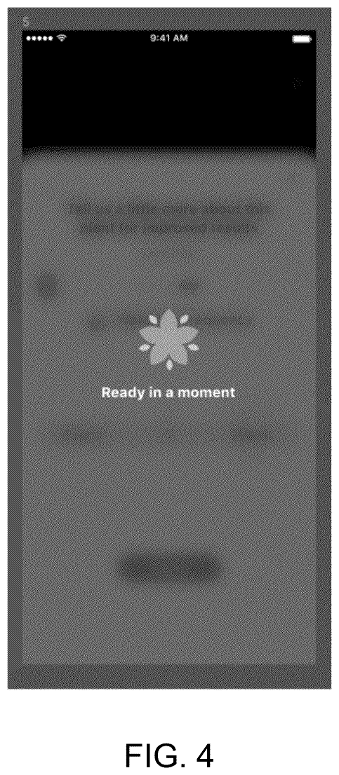

“Skip” or “Done” may be displayed in the skip or done button 316. In the case where “Skip” is displayed in the skip or done button 316, the next page may be displayed in response to the user's operation. For instance, in the case of displaying in the order of FIG. 3A to FIG. 3D, in response to the user's operation of the skip or done button 316 in FIG. 3A, the page shown in FIG. 3B may be displayed to the user. In the case where “Done” is displayed in the skip or done button 316, display of the current page may be ended in response to the user's operation. For instance, the skip or done button 316 in FIG. 3D is displayed as “Done”, and in response to the user's operation of the skip or done button 316 in FIG. 3D, the page shown in FIG. 3D is displayed at the end. In some embodiments, after the display of the page shown in FIG. 3D is ended, a waiting page shown in FIG. 4 may be displayed to the user. During the time the waiting page is displayed, steps S120 and S130 to be described in the following paragraphs may be performed.

In step S120, a reference caring plan is determined according to the plant species. As some implementations, a corresponding relationship between the plant species and the reference caring plan may be stored in a database in advance, so that the corresponding reference caring plan may be determined according to the plant species.

In step S130, a mistake in the user caring plan is determined based on a difference between the user caring plan and the reference caring plan.

For instance, the plant requires full sun in the reference caring plan, but the light condition in the user caring plan is partial sun. In this case, it can be determined that the mistake in the user caring plan is due to unqualified light condition. In some embodiments, the mistake in the user caring plan may also be determined in combination with disease and insect pest information and/or health information of the plant, and description thereof is going to be provided in the following paragraphs in combination with some embodiments.

In step S140, prompt information related to plant caring is outputted to the user based on the mistake in the user caring plan. The prompt information may include, for example, a description of the mistake and/or a suggestion related to the reference caring plan. The corresponding relationship between the mistake in the user caring plan and the output of the prompt information related to plant caring to the user is going to be introduced in the following paragraphs with reference to some embodiments.

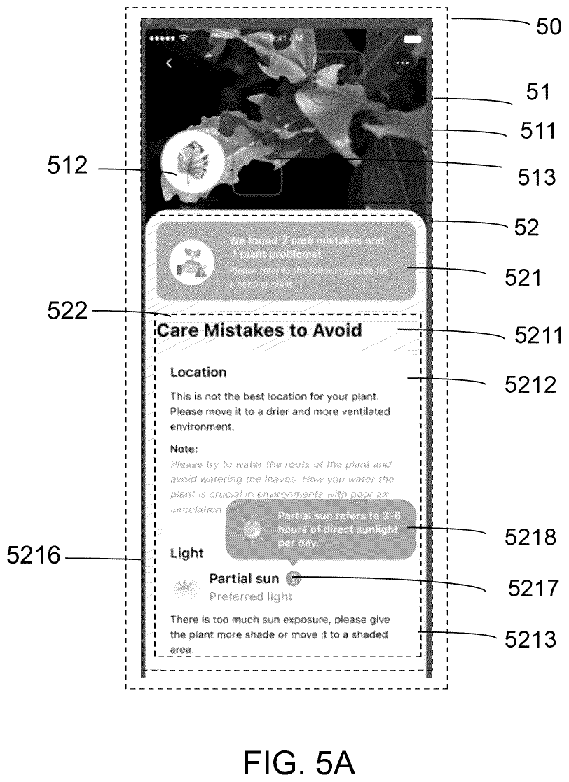

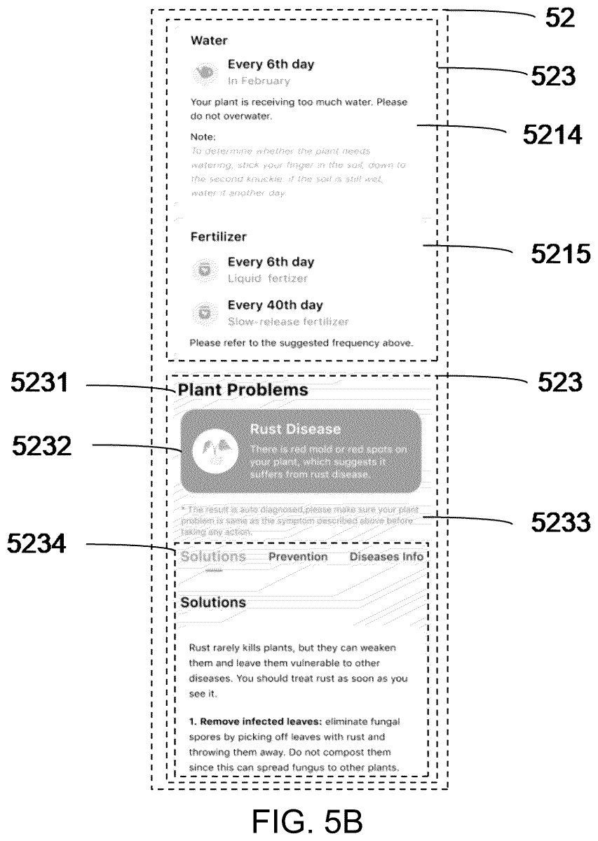

FIG. 5A and FIG. 5B are schematic images of pages for displaying prompt information related to plant caring in the method configured for assisting the user in caring for the plant according to some embodiments of the disclosure. The following describes how to output the prompt information related to plant caring to the user with reference to FIG. 5A and FIG. 5B. As shown in FIG. 5A, a page 50 for displaying the prompt information related to plant caring may include an area 51 for displaying the plant image and an area 52 for displaying the prompt information. The area 51 may include a plant image 511. This area 52 may include a sub-area 521 for summarizing care problems and an area 522 for displaying the care problems.

The sub-area 521 may include, for example, a textual summary of the care problems—“We found 2 care mistakes and 1 plant problem! Please refer to the following guide for a happier plant. Herein, the number of the care mistakes may be determined based on the number of mistakes determined in step S130. For instance, if it is determined in step S130 that there are problems with the planting locations, light conditions, and water conditions, the number of care mistakes may be determined to be 3. The number of plant problems may be determined based on disease and insect pest information and/or health information to be described in the following paragraphs. The sub-area 521 may also include an icon to make the page 50 more vivid, so that the user's reading experience may thus be improved.

The sub-area 522 may include a title 5211, planting location-related caring prompt information 5212, light condition-related caring prompt information 5213, water condition-related caring prompt information 5214, and fertilizer condition-related caring prompt information 5215. The title 5211 is, for example “Care Mistakes to Avoid”. The planting location-related caring prompt information 5212 is, for example, a description of a located-related care mistake—“This is not the best location for your plant. Please move it to a drier and more ventilated environment”. As some implementations, the planting location-related caring prompt information 5212 may also include a suggestion for caring related to the location—“Please try to water the roots of the plant and avoid watering the leaves. How you water the plant is crucial in environments with poor air circulation”.

The light condition-related caring prompt information 5213 is, for example, a description of a light-related care mistake—“There is too mush sun exposure, please give the plant more shade or move it to a shaded area”. As some implementations, the light condition-related caring prompt information 5213 may further include a light condition in the reference caring plan 5216—“Partial sun (Preferred light)”, so that the user can concisely and clearly know what kind of light condition the plant needs. As some implementations, a details button 5217 may also be displayed to the user. In response to the user's operation of the details button 5217, a detailed introduction 5218 to the light condition in the reference caring plan may be displayed to the user. For instance, when the light condition in the reference caring plan 5216 is partial sun, the detailed introduction 5218 may be “Partial sun refers to 3-6 hours of direct light per day”. Since many users may not be clear about the classification of light conditions, showing the users a detailed introduction may help the users have a deeper understanding of the light conditions, so that the users may better care for the plants.

The water condition-related caring prompt information 5214 may include, for example, a description of the care mistake related to watering—“Your plant is receiving too much water. Please do not overwater”, as well as suggestions on watering-related caring—“It is recommended to water every 6th day in February”, and “To determine whether the plant needs watering, stick your finger in the soil, down to the second knuckle. If the soil is still wet, water it another day”. The fertilizer condition-related caring prompt information 5215 may include, for example, suggestions on fertilizer-related caring—“If it is liquid fertilizer, please fertilize every 6^{th} day” and “If it is slow-release fertilizer, please fertilize every 40^{th} day”. It should be understood that the caring prompt information displayed in the sub-area 522 is determined based on the mistake in the caring plan determined in step S130, and is not limited to the four pieces of caring prompt information, namely the location-related caring prompt information 5212, the light condition-related caring prompt information 5213, and water condition-related caring prompt information 5214, and the fertilizer condition-related caring prompt information 5215 listed in FIG. 5A. When the caring prompt information is displayed, user perception may be improved by bolding keywords and displaying corresponding icons. Part of the content in FIG. 5A and FIG. 5B (such as the area 523 used to display plant diseases) is not introduced herein and is going to be further introduced in the following paragraphs.

Since most people probably do not know how to properly care for plants, it is not easy for them to find out if there are mistakes in their caring plans. Even if people know there are mistakes in their caring plans, they may not know how to correct these mistakes. In the above embodiments, caring-related questions are outputted to the user, and then problems in the caring plan of the user are discovered, and finally tips are provided to the user. This can effectively help users realize whether there are problems with their caring plans. If there are problems, users can make corrections according to the tips, thereby effectively helping users better care for their plants.

In the following, how to determine the caring-related questions is introduced.

In some embodiments, before the questions are outputted, the caring-related questions may be generated according to the plant species. In this way, the generated caring-related questions are targeted, so that the user may be well assisted in caring for the plant. For instance, when the plant species is aquatic/hydroponic plant, the caring-related questions may not involve aspects such as the soil conditions, the flower pot conditions, and the water conditions, but mainly involve aspects such as the light conditions, the fertilizer conditions, and the planting duration.

In some embodiments, before the caring-related questions are outputted, the caring abilities and/or planting experiences of the user may be acquired, so as to generate the caring-related questions according to the caring abilities and/or the planting experiences. The caring-related questions generated in this way fully considers the characteristics of the user him/herself, so that the user may be well assisted in caring for the plant.

As some implementations, the caring-related questions may be generated according to the planting experiences. The following is a combination of Table 1 and Table 2 to introduce how to generate the caring-related questions based on the planting experiences. Table 1 and Table 2 are lists of care questions according to different embodiments of the disclosure. As shown in Table 1 and Table 2, in response to receiving the request for analyzing the caring situation submitted by the user for the first time, questions that can be outputted to the user include care questions including planting experiences. If the user's answers indicate that the user has little or no planting experience, in response to receiving the request for analyzing the caring situation submitted by the user for the second, third, or multiple times (>4), caring-related questions as shown in Table 1 may be outputted to the user. If the user's answers indicate that the user's planting experience is average or the user has a lot of planting experience, caring-related questions as shown in Table 2 may be outputted to the user.

TABLE 1

| First-time | | Second-time | | Third-time | | Multiple- | |
|---|---|---|---|---|---|---|---|
| asking | Note | asking | Note | asking | Note | time asking | Note |
| planting | | planting | ask | planting | ask | planting | ask |
| experience | | location | regularly | location | regularly | location | regularly |
| climate | | watering | ask | watering | ask | watering | ask |
| condition | | frequency | regularly | frequency | regularly | frequency | regularly |
| planting | ask | light | ask | light | ask | light | ask |
| location | regularly | condition | regularly | condition | regularly | condition | regularly |
| watering | ask | size of | ask about | soil | asking is | size of | asking is |
| frequency | regularly | flower pot | soil | condition | not | flower pot | not |
| | | | condition | | required | | required |
| | | | for ground | | for ground | | for ground |
| | | | planting | | planting | | planting |
| light | ask | fertilizer | | planting | | planting | |
| condition | regularly | condition | | duration | | duration | |

TABLE 2

| First-time | | Second-time | | Third-time | | Multiple- | |
|---|---|---|---|---|---|---|---|
| asking | Remark | asking | Remark | asking | Remark | time asking | Remark |
| planting | | planting | ask | planting | ask | planting | ask |
| experience | | location | regularly | location | regularly | location | regularly |
| climate | | watering | ask | watering | ask | watering | ask |
| condition | | frequency | regularly | frequency | regularly | frequency | regularly |
| planting | ask | light | ask | light | ask | light | ask |
| location | regularly | condition | regularly | condition | regularly | condition | regularly |
| watering | ask | size of | ask about | fertilizer | asking is | | asking is |
| frequency | regularly | flower pot | fertilizer | condition | not | | not |
| | | | condition | | required | | required |
| | | | for ground | | for ground | | for ground |
| | | | planting | | planting | | planting |
| light | ask | soil | planting | | | | |
| condition | regularly | condition | duration | | | | |

TABLE 3

| First-time asking | Remark | Not first-time asking | Remark |
|---|---|---|---|
| planting location | ask | planting location | ask |
| | regularly | | regularly |
| watering frequency | ask | watering frequency | ask |
| | regularly | | regularly |
| light condition | ask | light condition | ask |
| | regularly | | regularly |
| fertilizer condition | | soil condition | |
| climate condition | | ask about size of flower pot | |
| | | for non-ground planting, | |
| | | ask about planting duration | |
| | | for ground planting | |

In some embodiments, in response to receiving the request for analyzing the caring situation submitted by the user for the first time, the caring-related questions outputted to the user involve one or more aspects among the caring abilities, the planting experiences, and the climate conditions, and involve one or more aspects among the light conditions, the planting locations, the water conditions, the fertilizer conditions, the soil conditions, the flower pot conditions, and the planting duration. Further, in response to receiving the request for analyzing the caring situation submitted by the user not for the first time, the caring-related questions outputted to the user involve one or more aspects among the light conditions, the planting locations, the water conditions, the fertilizer conditions, the soil conditions, the flower pot conditions, and the planting duration. That is, if it is not the first time to ask a question, it does not need to involve aspects such as the caring abilities, the planting experiences, and the climate conditions.

For instance, as shown in Table 3, in response to receiving the request for analyzing the caring situation submitted by the user for the first time, the caring-related question outputted to the user may involve the planting locations, the watering frequency, and the light conditions. In addition, the fertilizer conditions and the climate conditions may also be involved. In response to receiving the request for analyzing the caring situation submitted by the user not for the first time, the caring-related questions outputted to the user may involve the light conditions, the planting locations, and the water conditions. In addition, the soil conditions and the flower pot conditions may also be involved.

For another instance, as shown in Table 1, in response to receiving the request for analyzing the caring situation submitted by the user for the first time, the caring-related questions outputted to the user may involve the caring abilities, the planting experiences, the climate conditions, the light conditions, the planting locations, and the water conditions. Further, in response to receiving the request for analyzing the caring situation submitted by the user for the second time, the caring-related questions outputted to the user involves the light conditions, the planting locations, the water conditions, the soil conditions/flower pot conditions, and the fertilizer conditions.

In some embodiments, the caring-related questions involve a predetermined number of aspects, such as up to five aspects, among the light conditions, the planting locations, the water conditions, the fertilizer conditions, the soil conditions, the flower pot conditions, and the planting duration. Limiting the number of the caring-related questions to less than 5 can avoid the situation where user experience is degraded due to too many questions.

In some embodiments, in response to receiving the request for analyzing the caring situation for the first time among the two received consecutive requests for analyzing the caring situation submitted by the user, the questions are a first subset of questions. In response to receiving the request for analyzing the caring situation for the second time among the two received consecutive requests for analyzing the caring situation submitted by the user, the questions are a second subset of questions. Both the first subset of questions and the second subset of questions include some (but not all) aspects among the light conditions, the planting locations, the water conditions, the fertilizer conditions, the soil conditions, the flower pot conditions, and the planting duration Further, the first subset of questions and the second subset of questions do not completely overlap. In this way, the questions asked to the user twice in a row are not exactly the same, so that the user experience may be improved.

For instance, as shown in FIG. 1, in response to the request for analyzing the caring situation submitted by the user for the third time, the first subset of questions may include the planting locations, the water conditions, the light conditions, the soil conditions, and the planting duration. In response to the request for analyzing the caring situation submitted by the user for the fourth time, the second subset of questions may include the planting locations, the watering frequency, the light conditions, the size of the flow pot, and the planting duration.

For another instance, since the climate conditions generally do not change, the first subset of questions may include the climate conditions and the second subset of questions may no longer include the climate conditions.

In the above embodiments, by setting the first subset of questions and the second subset of questions that are not completely identical, rich and comprehensive caring information may be acquired from the user, so that the caring tips may be determined accurately and comprehensively.

The following describes how to determine a mistake in the user caring plan and the corresponding relationship between the mistake in the user caring plan and the output of the prompt information related to plant caring to the user with reference to some embodiments.

In some embodiments, where the user caring plan indicates that the planting location is indoor, ventilation may be considered poor, and where the user caring plan indicates that the planting location is outdoor, ventilation may be considered good. Therefore, if the user caring plan indicates that the planting location is indoor and the disease and insect pest information and/or the health information of the plant indicates that the plant has a disease, the prompt information related to plant caring outputted to the user may be the planting location-related caring prompt information 5212 shown in FIG. 5A—“This is not the best location for your plant. Please move it to a drier and more ventilated environment” and “Please try to water the roots of the plant and avoid watering the leaves. How you water the plant is crucial in environments with poor air circulation”.

In some embodiments, in the case where the mistake in the user caring plan is that the light is too strong, the prompt information related to plant caring outputted to the user may be “There is too mush sun exposure, please give the plant more shade or move it to a shaded area”. In the case where the mistake in the user caring plan is that the light is too weak, the prompt information related to plant caring outputted to the user may be “Your plant needs more light, please move it to a brighter location”. In the case where the user caring plan indicates that the light condition is appropriate, the prompt information related to plant caring outputted to the user may be “Your plant is receiving sufficient light.”

In some embodiments, in the case where the mistake in the user caring plan is too much water, the prompt information related to plant caring outputted to the user may be “Your plant is receiving too much water. Please do not overwater”. In the case where the mistake in the user caring plan is too little water, the prompt information related to plant caring outputted to the user may be “Your plants may need more water”. In the case where the user caring plan indicates that the water condition is appropriate, the prompt information related to plant caring outputted to the user may be “Your plant is receiving sufficient water.”

In some embodiments, there is a correlation among different aspects such as the light conditions, the planting locations, the water conditions, the fertilizer conditions, the soil conditions, the flower pot conditions, and the planting duration. When a mistake in the user caring plan is determined, the correlation among different aspects of the problems needs to be comprehensively considered.

As some implementation methods, both the planting locations and the light conditions may be combined to comprehensively consider whether the light conditions in the user caring plan meet the needs. For instance, when the planting location is outdoor and the light condition in the user caring plan is full sun, if the plant in the reference caring plan needs full sun, the light is judged to be appropriate, and if the plant in the reference caring plan does not need full sun, the light is judged to be too strong. When the planting location is outdoor and the light condition in the user caring plan is partial sun, if the plant in the reference caring plan needs full sun or partial sun, the light is judged to be appropriate, and if the plant in the reference caring plan needs full shade or indirect sunlight, the light is judged to be too strong. When the planting location is indoor and the light condition in the user caring plan is full sun, if the plant in the reference caring plan needs full sun or partial sun, the light is judged to be appropriate, and if the plant in the reference caring plan needs full shade or indirect sunlight, the light is judged to be too strong. When the planting location is outdoor and the light condition in the user caring plan is indirect sunlight, if the plant in the reference caring plan needs full sun, the light is judged to be insufficient, if the plant in the reference caring plan needs partial sun or indirect sunlight, the light is judged to be appropriate, and if the plant in the reference caring plan needs full shade, the light is judged to be too strong. When the planting location is indoor and the light condition in the user caring plan is partial sun, if the plant in the reference caring plan needs full sun, the light is judged to be insufficient, if the plant in the reference caring plan needs partial sun or indirect sunlight, the light is judged to be appropriate, and if the plant in the reference caring plan needs full shade, the light is judged to be too strong. When the planting location is outdoor and the light condition in the user caring plan is full shade, if the plant in the reference caring plan needs full sun or partial sun, the light is judged to be insufficient, and if the plant in the reference caring plan needs indirect sunlight or full shade, the light is judged to be appropriate. When the planting location is indoor and the light condition in the user caring plan is indirect sunlight, if the plant in the reference caring plan needs full sun or partial sun, the light is judged to be insufficient, and if the plant in the reference caring plan needs indirect sunlight or full shade, the light is judged to be appropriate. When the planting location is indoor and the light condition in the user caring plan is full shade, if the plant in the reference caring plan needs full shade, the light is judged to be appropriate, and if the plant in the reference caring plan does not need full shade, the light is judged to be insufficient.

In the following paragraphs, how to combine the disease and insect pest information and/or the health information of the plant to determine a mistake in the user caring plan is introduced in combination with some embodiments.

In some embodiments, before a mistake is determined, at least one of the disease and insect pest information and the health information of the plant is acquired, and the mistake is then determined according to at least one of the disease and insect pest information and the health information and the difference between the user caring plan and the reference caring plan. Herein, the disease and insect pest information includes, for example, one or more of fungal diseases, bacterial diseases, viral diseases, nematode diseases, aphids, fruit flies, spider mites, scale insects, and whiteflies. The health information includes, for example, one or more of lack of water, lack of light, and lack of ventilation. Since there is usually a correlation between plant caring and the disease and insect pest/health of the plant, combining the disease and insect pest information and/or the health information may more accurately determine a mistake in the user caring plan, and vice versa.

For instance, when the disease and insect pest information of the plant indicates plant root rot, combined with the user's answer to the question related to the caring plan, it can be determined that the mistake in the user caring plan is that the watering frequency is too frequent, thus prompting the user to reduce watering.

In some embodiments, the prompt information may include at least one of the disease and insect pest information and the health information and a description of a plant status corresponding to at least one of the disease and insect pest information and the health information. By displaying the description of the plant status corresponding to at least one of the disease and insect pest information and the health information to the user, it is helpful for the user to judge whether the disease and insect pest information and the health information determined in the disclosure are correct based on the description of the plant status. On the one hand, it can avoid misjudgment of the disease and insect pest information and the health information due to the disclosure, causing the user to incorrectly care for the plant. On the other hand, it can also help the user learn more about the disease and insect pests and health of the plant, so that the user's caring level may be improved.

As shown in FIG. 5B, an area 52 for displaying the prompt information may include a sub-area 51 for displaying the disease and insect pest information and the health information. The sub-area 523 may include a sub-area name 5231, a disease and insect pest information and health information and corresponding plant status description 5232, a disease and insect pest information and health information note 5233, a disease and insect pest information and health information-related solution, prevention method, and detailed introduction 5234. The sub-area name 5231 is, for example, “Plant Problems”. The disease and insect pest information and health information and corresponding plant status description 5232 is, for example, “Rust Disease” and “There is a red mold or red spots on your plant, which suggests it suffers from rust disease”. The disease and insect pest information and health information note 5233 is, for example, “This result is auto diagnosed, please make sure your plant problem is same as the symptom described above before taking any action”. The disease and insect pest information and health information-related solution, prevention method, and detailed introduction 5234 may include three parts: a disease and insect pest information and health information-related solution, a disease and insect pest information and health information-related prevention method, and a disease and insect pest information and health information-related detailed introduction.

In some embodiments, a plant image may be acquired, and at least one of the disease and insect pest information and the health information of the plant may be determined based on the plant image. A related portion on the plant image is marked according to at least one of the disease and insect pest information and the health information. The outputting the prompt information may include outputting the marked plant image. As shown in FIG. 5A, a mark box 513 may be used to mark a related portion of the plant image 511. By marking the image, it is helpful for the user to intuitively see which part of the plant has problems. Further, the user may combine the marked image with the disease and insect pest information and/or the health information shown in the prompt information, so that the user may gain a more comprehensive and in-depth understanding of the disease and insect pest information and/or the health information, and the user's caring level may thus be improved. In addition, an exemplary image related to the disease and insect pest information and the health information may also be shown in the area 512. Arrangement of an exemplary image also helps the user gain a more comprehensive and in-depth understanding of the disease and insect pest information and/or the health information, so that the user's caring level may be improved.

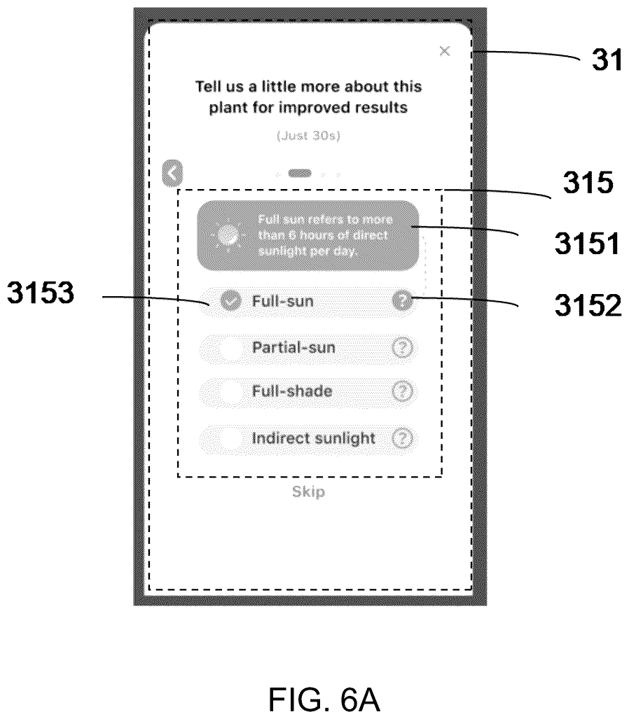

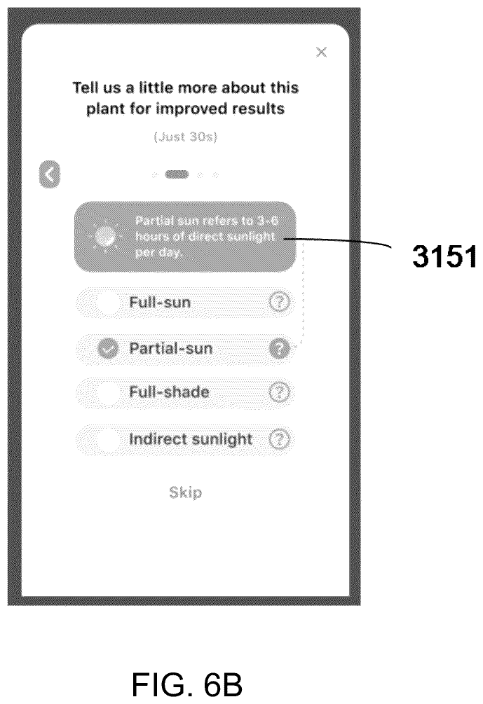

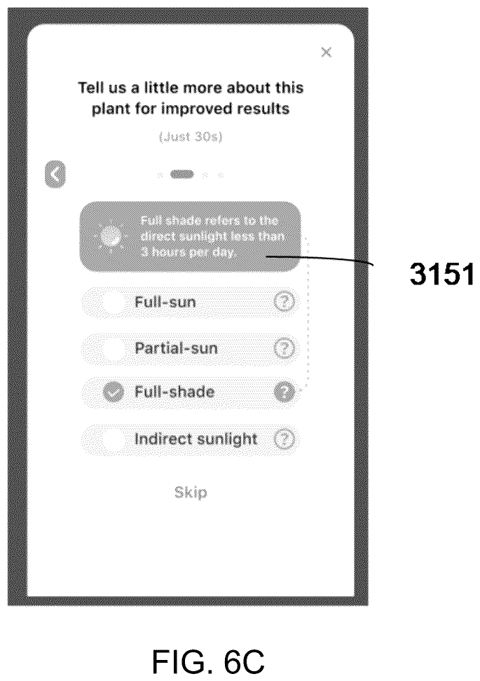

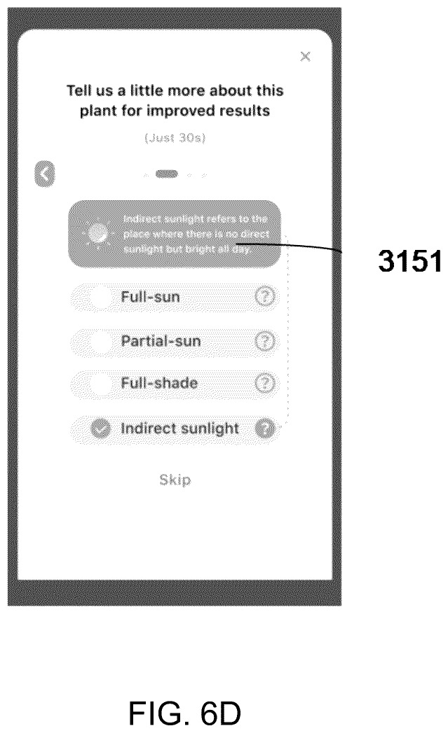

In some embodiments, as shown in FIG. 3B and FIG. 6A to FIG. 6D, the caring-related question may involve light conditions. In this case, an introduction to each light condition can be outputted to make the user's answer to the question more accurate. The light conditions include, for example, full sun, partial sun, full shade, and indirect sunlight. As shown in FIG. 6A, an introduction 3151 for full sun is, for example, “Full sun refers to more than 6 hours of direct sunlight per day”. As shown in FIG. 6B, the introduction 3151 for partial sun is, for example, “Partial sun refers to 3-6 hours of direct sunlight per day”. As shown in FIG. 6C, the introduction 3151 for full shade is, for example, “Full shade refers to the direct sunlight less than 3 hours per day”. As shown in FIG. 6D, the introduction 3151 for indirect sunlight is, for example, “Indirect sunlight refers to the place where there is not direct sunlight but bright all day”.

As some implementations, the planting experiences and/or caring abilities of the user may be acquired before the questions are outputted. Further, whether to output an introduction of each of the light conditions to the user is determined based on the planting experiences and/or the caring abilities. In response to determining to output the introduction to each of the light conditions to the user, an introduction to each of the light conditions is outputted to the user. For instance, in the case where the user has less planting experience and/or poor caring abilities, the introduction to each of the light conditions may be outputted to the user. In the case where the user has more planting experiences and/or has better caring abilities, no introduction to each of the light situations is outputted to the user. For users with more planting experiences/good caring abilities, they often already have a better understanding of various light conditions, so there is no need to show them the introduction to various light conditions. For users with little planting experiences and poor caring abilities, they are not familiar with the classification of light conditions, so it is necessary and helpful to show them the introduction to various light conditions. Determining whether to output the introduction to each of the light conditions to users based on the planting experiences and/or the caring abilities is conducive to fully considering the respective needs of different users and improving user experiences.

As some implementations, when the questions are outputted, in response to a specific operation by the user, the introduction of each of the light conditions is outputted. For instance, as shown in FIG. 5A, a light condition introduction 3151 may be displayed in response to the user's operation of a question button 3152. For another instance, as shown in FIG. 5A, in response to the user's operation on a light option 3153, the light condition introduction 3151 corresponding to the light option 3153 may be displayed.

Each embodiment in the specification is described in a progressive manner. Each embodiment focuses on its differences from other embodiments, and the same or similar parts among various embodiments may be referred to one another. As for a device embodiment, since it basically corresponds to the method embodiment, the description is relatively simple. For relevant details, please refer to the partial description of the method embodiment.

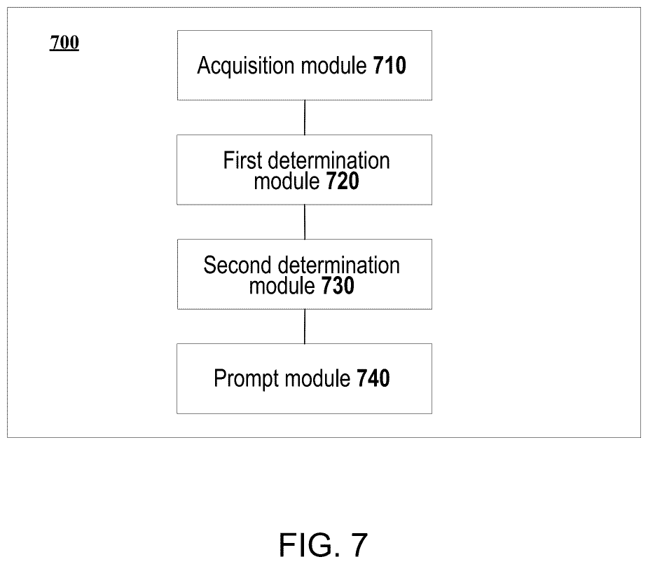

FIG. 7 is a schematic structural view of a device configured for assisting a user in caring for a plant according to some embodiments of the disclosure.

As shown in FIG. 7, a device configured for assisting a user in caring for a plant 700 includes an acquisition module 710, a first determination module 720, a second determination module 730, and a prompt module 740. The acquisition module 710 is configured to acquire a plant species in response to a request for analyzing a caring situation submitted by the user and output caring-related questions to the user, so as to determine a user caring plan through answers to the questions from the user. The first determination module 720 is configured to determine a reference caring plan according to the plant species. The second determination module 730 is configured to determine a mistake in the user caring plan based on a difference between the user caring plan and the reference caring plan. The prompt module 740 is configured to output prompt information related to plant caring to the user based on the mistake.

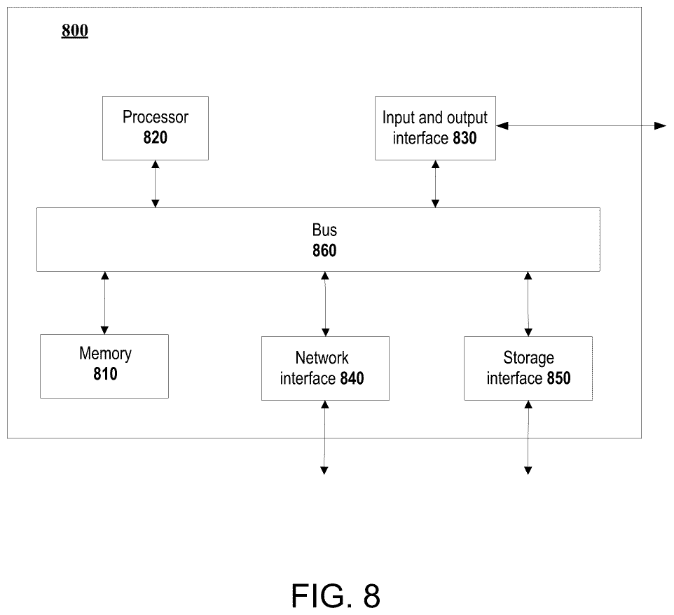

FIG. 8 is a schematic structural view of a device configured for assisting a user in caring for a plant according to some other embodiments of the disclosure.

As shown in FIG. 8, a device configured for assisting a user in caring for a plant 800 includes a memory 810 and a processor 820 coupled to the memory 810. The processor 820 is configured to execute the method according to any one of the foregoing embodiments based on a command store in the memory 810.

The memory 810 may include, for example, a system memory, a fixed non-volatile storage medium, etc. The system memory may store, for example, an operating system, an application program, a boot loader, and other programs.

The device configured for assisting the user in caring for the plant 800 may further include an input and output interface 830, a network interface 840, a storage interface 850, and the like. These interfaces 830, 840, and 850, the memory 810, and the processor 820 may be connected through a bus 860, for example. The input and output interface 830 provides a connection interface for input and output devices such as a monitor, a mouse, a keyboard, and a touch screen. The network interface 840 provides a connection interface for various networked devices. The storage interface 850 provides a connection interface for an external storage device such as a SD card and a USB disk.

An embodiment of the disclosure further provides a computer-readable storage medium including a computer program command. The computer program command, when being executed by a processor, implements the method of any one of the foregoing embodiments.

An embodiment of the disclosure further provides a computer program product including a computer program. Herein, the computer program, when being executed by a processor, implements the method of any one of the foregoing.

Various embodiments of the disclosure have been described in detail so far. To avoid obscuring the concepts of the disclosure, some details that are well known in the art have not been described. Based on the above description, a person having ordinary skill in the art can completely understand how to implement the technical solution disclosed herein.

A person having ordinary skill in the art will understand that embodiments of the disclosure may be provided as methods, systems, or computer program products. Accordingly, the disclosure may take the form of an entirely hardware embodiment, an entirely software embodiment, or an embodiment that combines software and hardware aspects. Further, the disclosure may take the form of a computer program product embodied on one or more computer-usable non-transitory storage media (including but not limited to a disk memory, a CD-ROM, an optical storage device, etc.) having computer-usable program code embodied therein.

The disclosure is described with reference to flow charts and/or block diagrams of methods, devices (systems), and computer program products according to the embodiments of the disclosure. It shall be understood that the functions specified in one or more processes in the flow chart illustrations and/or in one block or blocks in the block diagrams can be implemented by computer program commands. These computer program commands may be provided to the processor of a general-purpose computer, a special-purpose computer, an embedded processor, or other programmable data processing devices to produce a machine. In this way, the commands executed by the processor of the computer or other programmable data processing devices generate a device for implementing the functions specified in one or more processes in the flow chart and/or one or more blocks in the block diagram.

These computer program commands may also be stored in a computer-readable memory that may guide a computer or other programmable data processing devices to work in a specific manner. In this way, the commands stored in the computer-readable memory generate an article of manufacturing including the command device. The command device implements the functions specified in one or more processes in the flow chart and/or one or more blocks in the block diagram.

These computer program commands may also be loaded onto a computer or other programmable data processing devices, so that a series of operation steps may be executed on the computer or other programmable devices to generate processing of computer implementation. As such, the commands executed on the computer or other programmable devices provide steps for implementing the functions specified in one or more processes in the flow chart and/or one or more blocks in the block diagram.

Although some specific embodiments of the disclosure are described in detail by way of examples, a person having ordinary skill in the art should know that the above examples are provided for illustration only and not for the purpose of limiting the scope of the disclosure. A person having ordinary skill in the art shall understand that the above embodiments may be modified or some technical features may be equivalently replaced without departing from the scope and spirit of the disclosure. The scope of the disclosure is defined by the appended claims.

What is claimed is:

1. A method configured for assisting a user in caring for a plant, comprising:
acquiring a plant species in response to a request for analyzing a caring situation submitted by the user and outputting questions, which are caring-related, to the user, so as to determine a user caring plan through answers to the questions from the user;
determining a reference caring plan according to the plant species;
determining a mistake in the user caring plan based on a difference between the user caring plan and the reference caring plan; and
outputting prompt information related to plant caring to the user based on the mistake.

2. The method according to claim 1, wherein
the questions involve one or more aspects among light conditions, planting locations, water conditions, fertilizer conditions, soil conditions, flower pot conditions, climate conditions, and a planting duration.

3. The method according to claim 1, further comprising:
generating the questions according to the plant species before the questions are outputted.

4. The method according to claim 1, further comprising:
acquiring caring abilities and/or planting experiences of the user before the questions are outputted; and
generating the questions based on the caring abilities and/or the planting experiences.

5. The method according to claim 2, wherein
the questions further involve caring abilities and/or planting experiences.

6. The method according to claim 1, further comprising:
acquiring at least one of disease and insect pest information and health information of the plant before the mistake is determined, the disease and insect pest information comprises one or more of fungal diseases, bacterial diseases, viral diseases, nematode diseases, aphids, fruit flies, spider mites, scale insects, and whiteflies, and the health information comprises one or more of lack of water, lack of light, and lack of ventilation; and
determining the mistake based on at least one of the disease and insect pest information and the health information and the difference.

7. The method according to claim 1, wherein
the prompt information comprises a description of the mistake and/or a suggestion related to the reference caring plan.

8. The method according to claim 6, wherein
the prompt information comprises at least one of the disease and insect pest information and the health information and a description of a plant status corresponding to at least one of the disease and insect pest information and the health information.

9. The method according to claim 6, further comprising:
acquiring a plant image and determining at least one of the disease and insect pest information and the health information of the plant based on the plant image; and
marking a related portion on the plant image according to at least one of the disease and insect pest information and the health information,
wherein the outputting the prompt information comprises outputting the plant image, which is marked.

10. The method according to claim 2, wherein
the questions involve the light conditions, and the light conditions comprise one or more of full sun, partial sun, full shade, and indirect sunlight, and
the outputting the questions comprises outputting an introduction of each of the light conditions.

11. The method according to claim 10, further comprising:
acquiring planting experiences and/or caring abilities of the user before the questions are outputted; and
determining whether to output the introduction of each of the light conditions to the user based on the planting experiences and/or the caring abilities.

12. The method according to claim 10, further comprising:
outputting the introduction of each of the light conditions in response to a specific operation by the user when the questions are outputted.

13. The method according to claim 1, wherein the acquiring the plant species comprises:
acquiring directly from the user through human-computer interaction; and/or
acquiring according to a plant image inputted by the user through computer vision technology.

14. The method according to claim 1, wherein
in response to receiving the request for analyzing the caring situation submitted by the user for a first time, the questions involve one or more aspects among caring abilities, planting experiences, and climate conditions, and involves one or more the aspects among light conditions, planting locations, water conditions, fertilizer conditions, soil conditions, flower pot conditions, and planting duration, and
in response to receiving the request for analyzing the caring situation submitted by the user not for the first time, the questions involve one or more the aspects among the light conditions, the planting locations, the water conditions, the fertilizer conditions, the soil conditions, the flower pot conditions, and the planting duration.

15. The method according to claim 14, wherein
the questions involve up to five aspects among the light conditions, the planting locations, the water conditions, the fertilizer conditions, the flower pot conditions, and the planting duration.

16. The method according to claim 14, wherein
in response to receiving the request for analyzing the caring situation for the first time among two received consecutive requests for analyzing the caring situation submitted by the user, the questions are a first subset of questions, and
in response to receiving the request for analyzing the caring situation for a second time among the two received consecutive requests for analyzing the caring situation submitted by the user, the questions are a second subset of questions,
wherein both the first subset of questions and the second subset of questions comprise all aspects among the light conditions, the planting locations, the water conditions, the fertilizer conditions, the soil conditions, the flower pot conditions, and the planting location, and the first subset of questions and the second subset of questions do not completely overlap.

17. A device configured for assisting a user in caring for a plant, comprising:
an acquisition module, configured to acquire a plant species in response to a request for analyzing a caring situation submitted by the user and output caring-related questions to the user, so as to determine a user caring plan through answers to the questions from the user;
a first determination module, configured to determine a reference caring plan according to the plant species;
a second determination module, configured to determine a mistake in the user caring plan based on a difference between the user caring plan and the reference caring plan; and
a prompt module, configured to output prompt information related to plant caring to the user based on the mistake.

18. A device configured for assisting the user in caring for the plant, comprising:
a memory; and
a processor coupled to the memory and configured to execute the method according to claim 1 based on a command stored in the memory.

19. A computer-readable storage medium comprising a computer program command, wherein the computer program command implements the method according to claim 1 when being executed by a processor.

20. A computer program product comprising a computer program, wherein computer program implements the method according to claim 1 when being executed by a processor.
